(19) United States
(12) Patent Application Publication
(10) Pub. No.: US 2010/0228626 A1
(43) Pub. Date: Sep. 9, 2010

(54) CONTENT REPRODUCTION AND CONTENT PUBLICATION METHODS AND CLIENTS THEREFOR ENABLING CONTENT USER OR CONTENT PUBLISHER TO SELECT ADVERTISEMENT INSERTED IN MEDIA CONTENT

(75) Inventor: Sung-Bin Im, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/670,278

(22) PCT Filed: Apr. 14, 2008
(86) PCT No.: PCT/KR08/02081

§ 371 Date: Jan. 22, 2010

Related U.S. Application Data
(60) Provisional application No. 60/951,509, filed on Jul. 24, 2007.

(30) Foreign Application Priority Data
Dec. 13, 2007 (KR) 10-2007-0129900

(51) Int. Cl. G06Q 30/00; G06Q 50/00

(52) U.S. Cl. 705/14.49

(57) ABSTRACT

Provided are content reproduction and content publication methods and apparatus therefor. The content reproduction method selects an advertisement to be inserted in a media content by referring to information about advertisements which are insertable into the media content, inserts the selected advertisement into the media content received from a media server, and reproduces the media content having the selected advertisement inserted therein, thereby enabling a client reproducing the media content to dynamically configure the advertisements being inserted to the media content, according to a user selection. Thus, a content user can actively select advertisements to be watched.

### CROSS-REFERENCE TO RELATED PATENT APPLICATIONS

This application is a National Stage of International Application No. PCT/KR2008/002081 filed Apr. 14, 2008, claiming priority based on U.S. Provisional Application No. 60/951,509 filed Jul. 24, 2007 and Korean Patent Application No. 10-2007-0129900 filed on Dec. 13, 2007 in the Korean Intellectual Property Office, the disclosures of which are incorporated herein by reference in their entirety.

### BACKGROUND

1. Field

The exemplary embodiments relate to content reproduction and content publication methods and apparatus therefor, and more particularly, to content reproduction and content publication methods and apparatus therefore which enable a content user or a content publisher to select and to dynamically insert a predetermined advertisement in a media content.

2. Description of the Related Art

In line with the developments of wired/wireless networks, the use of media contents such as moving pictures and audio files has considerably increased. In particular, since the User Created Contents (UCC) culture has spread rapidly to the general public, many users, who passively utilized media contents provided by content providers, now actively and directly publish media contents.

When the content providers or service providers distribute media contents via wired/wireless networks, they add provider-selected advertisements in the media contents. This is described in detail with reference to FIG. 1.

FIG. 1 is a flowchart of a method in the related art of inserting an advertisement in a media content and distributing the media content.

Referring to FIG. 1, in operation 132, a client 120 sends a request for transmission of a predetermined media content to a media server 110. That is, a user requests transmission of a desired media content from the media server 110 via the client 120.

In operation 134, after the media server 110 has received the transmission request regarding the media content from the client 120, the media server 110 inserts a predetermined advertisement in the requested media content. After that, in operation 136, the media content including the predetermined advertisement is transmitted to the client 110.

According to the method illusttrated in FIG. 1, the predetermined advertisement inserted in the media content in operation 134 is decided by a selection of a content provider or a service provider which operates the media server 110. When the content provider or the service provider selects an advertisement of an advertiser, which pays an advertisement rate, as a predetermined advertisement to be inserted in the media content, the client 120 passively reproduces the media content having the advertisement which was inserted and transmitted by the media server 110.

In general, a publisher of UCC is a personal user. Thus, ownership of the UCC generally belongs to the personal user. However, as shown in FIG. 1, if the media server 110 selects the advertisement to be inserted in the media content, this is unfair since the content provider or the service provider, which operates the media server 110, has an advertisement rate profit by using the media content created by the personal user.

### SUMMARY

Exemplary embodiments provide content reproduction and content publication methods and an apparatus therefor which enable a content user or a content publisher to actively select an advertisement to be inserted in a media content for reproduction and publication of the media content.

At least one exemplary embodiment also provides a computer readable recording medium having a program recorded thereon for causing a computer to execute the content reproduction and content publication methods.

According to an aspect of the present invention, there is provided a content reproduction method enabling a client to reproduce a media content, the content reproduction method including the operations of selecting an advertisement to be inserted in the media content by referring to information about advertisements which are insertable into the media content; and receiving the media content from a media server, inserting the selected advertisement into the received media content, and reproducing the media content having the selected advertisement inserted therein.

The operation of selecting the advertisement may include the operations of requesting an advertisement server to transmit the information about the advertisements which are insertable into the media content; receiving the information about the advertisements which are insertable into the media content as a response to the request; and selecting the advertisement to be inserted in the media content, based on the received information.

According to another aspect of the present invention, there is provided a client for reproducing a media content, the client including an advertisement interface unit which selects an advertisement to be inserted in the media content by referring to information about advertisements which are insertable into the media content; a content interface unit which receives the media content from a media server; and a reproduction unit which inserts the selected advertisement into the received media content, and reproduces the media content having the selected advertisement inserted therein.

According to another aspect of the present invention, there is provided a content publication method of publishing a media content by a first client for providing the media content to a second client, the content publication method including the operations of receiving information about advertisements which are insertable into the media content to be provided to the second client; selecting an advertisement to be inserted in the media content, based on the received information; and transmitting information about the selected advertisement and the media content, thereby enabling the second client to insert the selected advertisement in the media content and to reproduce the media content having the selected advertisement inserted therein.

The operation of receiving the information may include the operation of receiving the information about the advertisements from an advertisement server which stores the information about the advertisements which are insertable into the media content.

According to another aspect of the present invention, there is provided a content reproduction method enabling a second client to reproduce a media content published by a first client, the content reproduction method including the operations of transmitting a transmission request about the media content to a media server which provides the media content; and receiving the media content from the media server, inserting an advertisement selected by the first client into the received media content, and reproducing the media content having the selected advertisement inserted therein.

According to another aspect of the present invention, there is provided a first client for publishing a media content to be provided to a second client, the first client including an advertisement interface unit which receives information about advertisements which are insertable into the media content to be provided to the second client, selects an advertisement to be inserted in the media content from among the advertisements, based on the received information, and transmits information about the selected advertisement; and a content interface unit which transmits the media content, thereby enabling the second client to refer to the information about the selected advertisement and reproduce the media content having the selected advertisement inserted therein.

According to another aspect of the present invention, there is provided a second client for reproducing a media content published by a first client, the second client including a content interface unit which transmits a transmission request for the media content to a media server which provides the media content, and receives the media content from the media server as a response to the request; and a reproduction unit which inserts an advertisement selected by the first client into the received media content, and reproduces the media content having the selected advertisement inserted therein.

According to another aspect of the present invention, there is provided a computer readable recording medium having recorded thereon a program which causes a computer to execute the content reproduction method and the content publication method.

According to another aspect of the present invention, there is provided a content reproduction method enabling a client to reproduce a media content, the content reproduction method including receiving advertisement library information from an advertisement server, the advertisement library information corresponding to advertisements stored in the advertisement server which are insertable intoto the media content; selecting an advertisement to be inserted in the media content from among the advertisements by referring to the advertisement library information; receiving the media content from a media server; receiving the selected advertisement from the advertisement server; inserting the selected advertisement into the received media content; and reproducing the received media content having the selected advertisement inserted therein.

According to another aspect of the present invention, there is provided a system for publishing and reproducing a media content, the system including an advertisement server which stores a plurality of advertisements; a first client which publishes a media content and selects at least one of the plurality of advertisements to be inserted into the media content; a media server which stores the published media content transmitted from the first client; and a second client which receives the published media content from the media server, receives the selected at least one advertisement from the advertisement server, inserts the selected at least one advertisement into the published media content, and reproduces the published media content having the selected at least one advertisement inserted therein.

The exemplary embodiments enable a content user watching the media content to insert a user-desired advertisement in the media content and to reproduce the media content having the advertisement, thereby enabling a content user to create various advertisement businesses. Also, exemplary embodiments enable a content publisher to directly decide an advertisement to be inserted in a media content of the content publisher, so that a true media content owner can receive an advertisement revenue.

### BRIEF DESCRIPTION OF THE DRAWINGS

The above and other features and advantages of the exemplary embodiments will become more apparent by describing in detail the exemplary embodiments with reference to the attached drawings in which:

FIG. 1 is a flowchart of a method in the related art of inserting an advertisement in a media content and distributing the media content;

FIG. 2 is a flowchart of a content reproduction method according to an exemplary embodiment;

FIG. 3 is a block diagram of a client for reproducing a media content, according to an exemplary embodiment;

FIG. 4 is a flowchart of a content publication method according to an exemplary embodiment;

FIG. 5 is a diagram illustrating mapping information of an advertisement, according to an exemplary embodiment; and

FIG. 6 is a block diagram of a first client for publishing a media content and a second client for reproducing the media content, according to an exemplary embodiment.

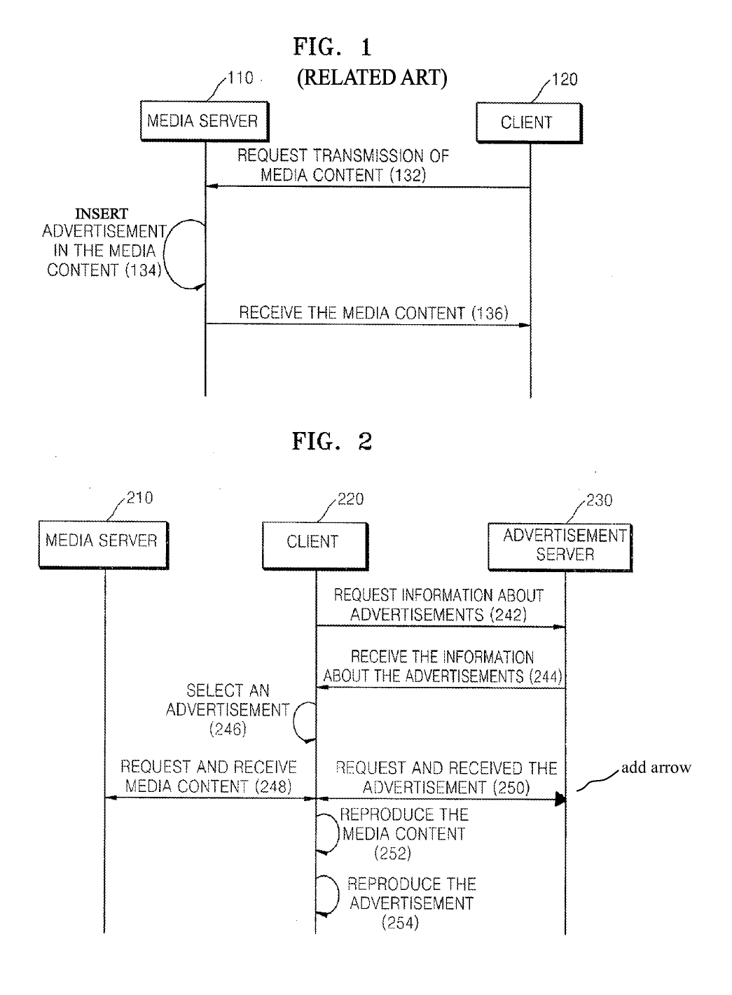

### DETAILED DESCRIPTION OF THE INVENTION

The exemplary embodiments will now be described more fully with reference to the accompanying drawings. Expressions such as “at least one of” when preceding a list of elements, modifies the entire list of elements and does not modify the individual elements of the list.

FIG. 2 is a flowchart of a content reproduction method according to an exemplary embodiment. The flowchart of FIG. 2 corresponds to the case in which a content user reproduces a media content in a media server 210, by using a client 220. Hereinafter, content reproduction and content publication methods and an apparatus therefor according to the exemplary embodiments will be described under the assumption that an advertisement server and a media server are separated from each other. However, one of skill in the art to which the present invention pertains may easily construe that a function of the advertisement server and a function of the media server can be carried out by a single server.

Referring to FIG. 2, in operations 242, 244, and 246, the client 220 refers to information about advertisements which are insertable into a media content to be reproduced by the client 220, and selects an advertisement to be inserted in the media content when the media content is reproduced.

In operation 242, the client 220 requests an advertisement server 230 for the information about the advertisements which are insertable into the media content reproduced by the client 220. At this time, information about an advertisement library which is stored by the advertisement server 230 may be requested.

In operation 244, the client 220 receives the information about the advertisements transmitted by the advertisement server 230, as a response to the request in operation 242. At this time, all pieces of the information about the advertisements which are insertable into the media content are received.

In operation 246, the client 220 selects an advertisement to be inserted in the media content to be reproduced by the client 220, based on the advertisement information received in operation 244. The selection may be performed by directly designating a specific advertisement which is to be inserted in the media content from among the advertisements included in the advertisement library. However, it may be possible not to directly designate the specific advertisement to be inserted in the media content, but alternatively, to designate only a category of an advertisement to be inserted in the media content.

The category such as a type of an advertised product, an entertainer (e.g., a person or animal) appearing in an advertisement, or an advertised company may be designated. For example, when the client 220 attempts to insert advertisements, in which entertainer A appears, in the media content, a category corresponding to entertainer A may be designated. Also, when the client 220 attempts to insert advertisements advertising a car in the media content, a category corresponding to the car may be designated.

After the client 220 selects a predetermined advertisement or a predetermined category, the advertisement server 230 may set the selected advertisement or the selected category as an advertisement-of-interest or a category-of-interest to the client 220, and may manage information about the client 220 by storing information about the advertisement-of-interest or the category-of-interest.

In operation 248, the client 220 sends a request to the media server 210 to transmit the media content to be reproduced, and receives the media content as a response to the request. Similarly, in operation 250, the client 220 sends a request based on the advertisement-of-interest or the category-of-interest to the advertisement server 230 to transmit the advertisement to be inserted in the media content, and receives the advertisement as a response to the request. In the case of a streaming transmission in which the media content is transmitted in real-time, the media server 210 and the advertisement server 230 exchange data, thereby enabling the client 220 to consecutively receive the media content and the advertisement in proper time. At this time, the data exchanged by the media server 210 and the advertisement server 230 may include metadata of the media content and metadata of the selected advertisement.

Also, in operation 250, when the client 220 receives the advertisement to be inserted in the media content which is to be reproduced, additional information about the advertisement may also be received. For example, a specification of an advertised product, a profile of an entertainer appearing in the advertisement, a history of an advertised company, or the like may be included in the additional information. A contact number for ordering the advertised product may also be included in the additional information.

In operation 252, the client 220 inserts the advertisement received in operation 250 into the media content received in operation 248, and reproduces the media content having the advertisement. The advertisement may be inserted before the media content is reproduced or while the media content is reproduced.

In the case where the advertisement is directly designated in operation 246, other advertisements included in a same category as the designated advertisement may be inserted in the media contents and reproduced. In the case where the client 220 has designated only the category of the advertisement in operation 246, other advertisements included in a category similar to the designated category may be inserted in the media content and reproduced. Also, another advertisement, except for the advertisement or the category selected by the client 220 in operation 246, maybe also be inserted. Thus, more than one advertisement may be inserted into the media content.

In operation 254, after the reproduction of the media content is completed, the client 220 extracts only the advertisement inserted in the media content reproduced in operation 252, and reproduces the advertisement again. In the case where a user of the client 220, which was interested in the contents of the advertisement during the reproduction of the media content, desires to watch the advertisement again, the client 220 may extract and reproduce again only the advertisement. In the case where the additional information about the advertisement was also received in operation 250, the additional information may also be provided to the user when only the advertisement is reproduced in operation 254.

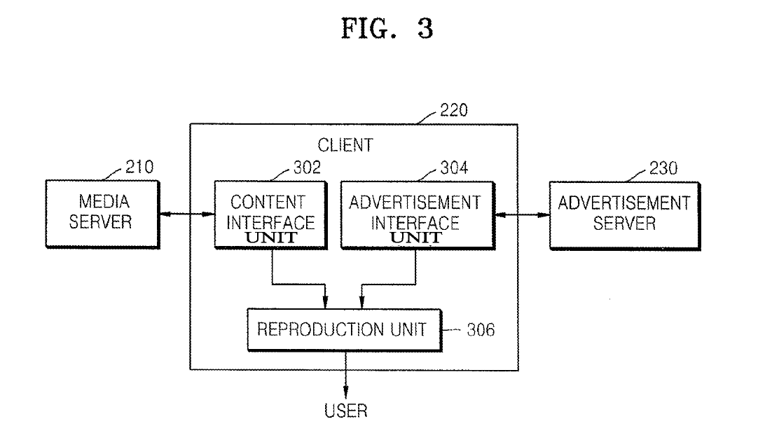

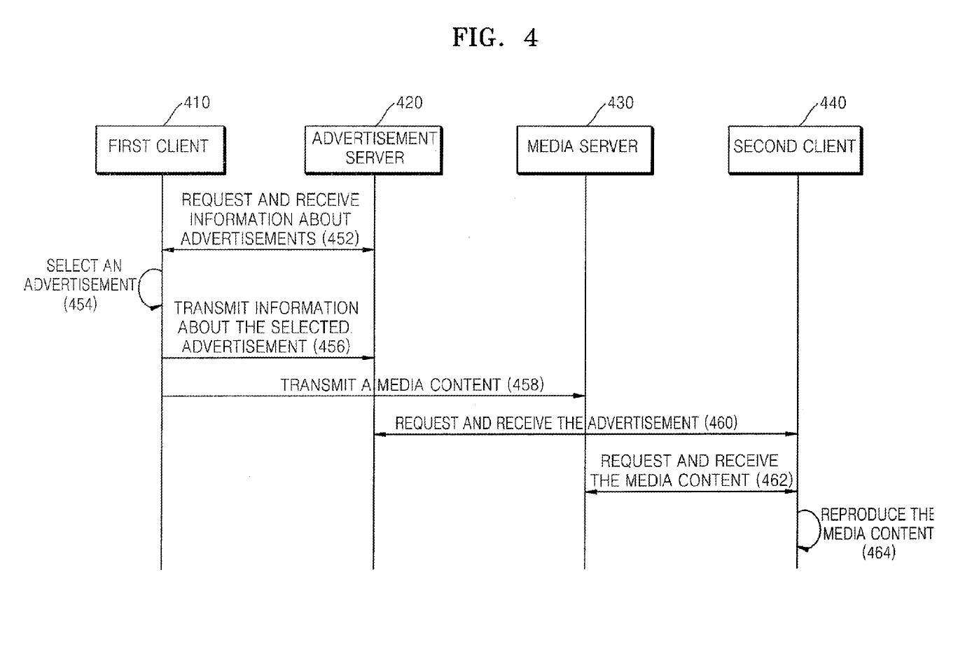

FIG. 3 is a block diagram of the client 220 for reproducing a media content, according to an exemplary embodiment. Referring to FIG. 3, the client 220 according to the exemplary embodiment includes a content interface unit 302, an advertisement interface unit 304, and a reproduction unit 306.

The content interface unit 302 requests the media content from the media server 210, and receives the media content as a response to the request.

The advertisement interface unit 304 refers to information about advertisements which are insertable into the media content received by the content interface 302, and selects an advertisement to be inserted in the media content according to the advertisement-of-interest or the category-of-interest. The advertisement interface unit 304 requests the advertisement server 230 for the information about the advertisements which are insertable into the media content to be reproduced, and selects the advertisement to be inserted in the media content by referring to the information about the advertisements, wherein the information is received as a response to the request. The selection may be performed by directly designating the advertisement to be inserted, or may be performed by designating only a category of the advertisement to be inserted. A description regarding the category is described above with reference to FIG. 2.

When the advertisement to be inserted in the media content is selected, the selected advertisement is requested from the advertisement server 230, and as a response to the request, the advertisement is received from the advertisement server 230. At this time, additional information about the advertisement may also be received, as described above.

The reproduction unit 306 inserts the advertisement received by the advertisement interface unit 304 into the media content received by the content interface unit 302, and reproduces the media content having the advertisement included therein. In the case where the advertisement interface unit 302 designates the category so as to select the advertisement to be inserted, advertisements included in a category similar to the designated category may be inserted in the media content and reproduced.

After the reproduction of the media content is completed, the reproduction unit 306 may also extract and separately reproduce only the inserted advertisements. A user may desire to re-watch the advertisements included in the media content, and in this case, only the advertisements are extracted and reproduced again. The additional information about the advertisement received by the advertisement interface unit 304 may also be provided to the user, as described above.

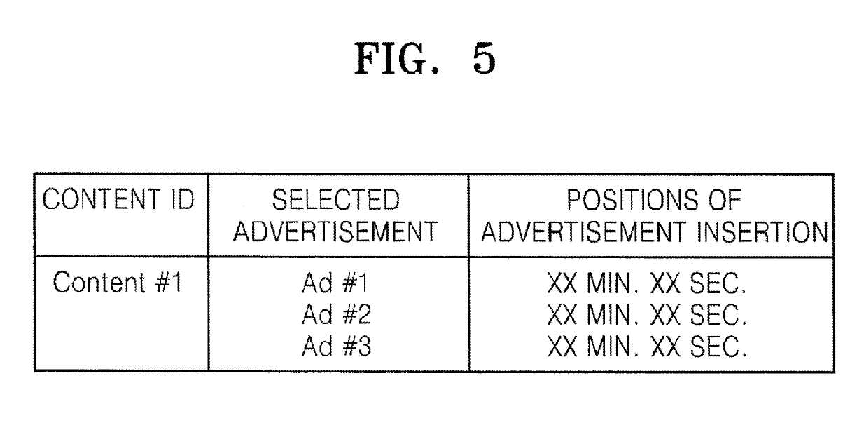

FIG. 4 is a flowchart of a content publication method according to an exemplary embodiment.

The flowchart of FIG. 4 corresponds to the case in which a first client 410 publishes a media content and uploads the published media content to a media server 430, and then a second client 440 reproduces the uploaded media content.

In operation 452, the first client 410 sends a request to an advertisement server 420 for information about advertisements which are insertable into the media content published by the first client 410, and receives the information about the advertisements, as a response to the request. The first client 410 may receive a list of the advertisements, which are capable of being inserted in the media content, from the advertisement server 420.

The first client 410 may receive a list of advertisements, which are uploaded in the advertisement server 420 by an advertiser, from the advertisement server 420. If a category of a media content capable of using the advertisements is pre-selected by the advertiser, an advertisement may be inserted only in the media content corresponding to the category. If the media content published by the first client 410 is not included in the category designated by the advertiser, the first client 410 receives the list of the advertisements, wherein the list excludes the advertisement of such an advertiser.

FIG. 4 corresponds to the case in which the information about the advertisements, which are insertable into the media content, is received from the advertisement server 420. However, there is no limitation to a method of receiving the information about the advertisements by the first client 410. The information about the advertisements may be received from the media server 430 or another client, and not solely from the advertisement server 420.

In operation 454, the first client 410 refers to the information about the advertisements received in operation 452, and selects an advertisement to be inserted in the media content published by the first client 410. As described above with reference to FIG. 2, the advertisement to be inserted may be selected by directly designating an advertisement in the list of the advertisements or may be selected by designating only a category of the advertisement to be inserted.

In operation 456, the first client 410 transmits information about the selected advertisement to the advertisement server 420. For example, mapping information is transmitted to the advertisement server 420, wherein the mapping information indicates a type of the media content published by the first client 410 and a type of the advertisement selected so as to be inserted in the media content.

FIG. 5 is a diagram illustrating mapping information of an advertisement, according to an embodiment of the present invention.

The mapping information of FIG. 5 indicates that a content identifier of a media content published by the first client 410 is ‘Content #1’, and advertisements selected to be inserted in ‘Content #1’ are respectively ‘Ad #1’, ‘Ad #2’, and ‘Ad #3’. Information indicating positions of the media content may be selectively included in the mapping information, wherein the advertisements are inserted at the positions designated by the position information.

Referring back to FIG. 4, FIG. 4 corresponds to the case in which the first client 410 transmits only the mapping information to the advertisement server 420 in operation 456. However, the first client 410 may transmit the mapping information to the media server 430 instead of to the advertisement server 420. Also, the first client 410 may transmit the mapping information to both the advertisement server 420 and the media server 430. The advertisement server 420 and the media server 430 mutually share the mapping information, thereby enabling the second client 440 to rotationally receive the media content and the advertisement in a proper timing.

In operation 458, the first client 410 transmits the published media content to the media server 430. The first client 410 uploads the published media content to the media server 430 operated by a content provider or a service provider, thereby enabling the second client 440 to receive and reproduce the media content.

In operation 460, the second client 440 sends a request to the advertisment server 420 for the advertisement which is to be inserted in the media content which is to be reproduced. As a response to the request, the second client 440 receives the advertisement which is selected, as the advertisement to be inserted, by the first client 410 in operations 452 and 454. In operation 462, the second client 440 sends a request to the media server 430 for the media content published by the first client 410, and receives the media content, as a response to the request.

In operation 464, the second client 440 inserts the advertisement received in operation 460 into the media content received in operation 462, and reproduces the media content having the advertisement.

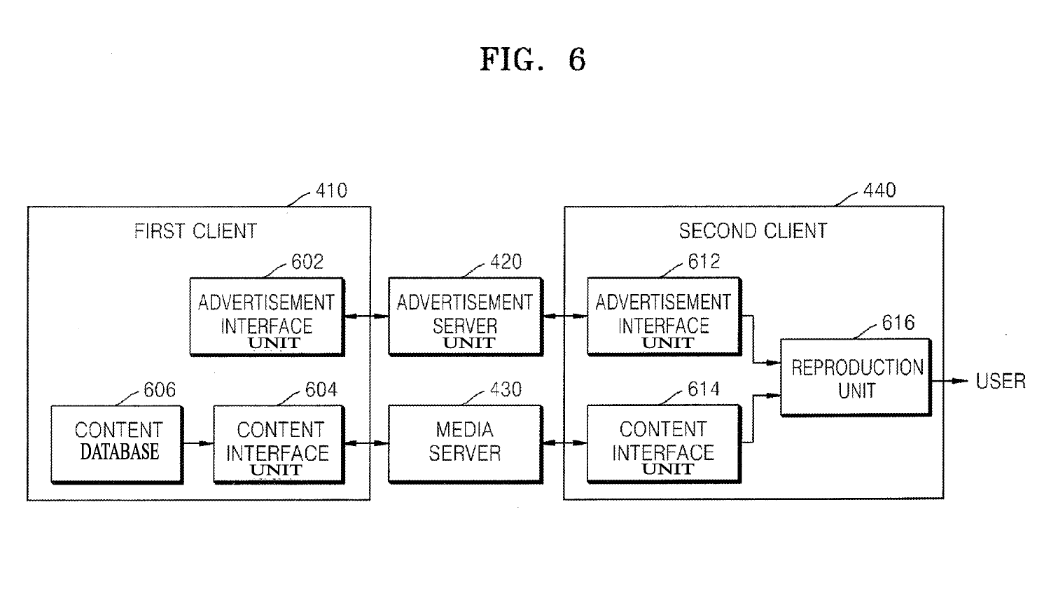

FIG. 6 is a block diagram of the first client 410 for publishing a media content and the second client 440 for reproducing the media content, according to an embodiment of the present invention.

Referring to FIG. 6, the first client 410 according to the present invention includes an advertisement interface unit 602, a content interface unit 604, and a content database 606.

The advertisement interface unit 602 requests information on advertisements which are insertable into the media content from the advertisement server 420, and receives the information about the advertisements as a response to the request. The advertisement interface 602 receives a list of the advertisements, which are insertable into the media content, from the advertisement server 420. Also, the advertisement interface unit 602 selects an advertisement to be inserted in the media content, based on the information received from the advertisement server 420, and transmits information about the selected advertisement to the advertisement server 420.

The mapping information including an identifier of the media content in which the advertisement is to be inserted, and including the information about the selected advertisement is transmitted to the advertisement server 420, as described above. The mapping information may be transmitted to the media server 430 instead of to the advertisement server 420, or may be transmitted to both of the advertisement server 420 and the media server430.

The content interface unit 604 transmits the published media content, which is stored in the content database 606, to the media server 430.

The second client 440 according to the present invention includes an advertisement interface unit 612, a content interface unit 614, and a reproduction unit 616.

The advertisement interface unit 612 requests an advertisement to be inserted in the media content to be reproduced from the advertisement server 420 and receives the advertisement selected by the first client 410 as a response to the request. The content interface unit 612 sends a request for the media content, which is published by the first client 410 and uploaded to the media server 430, to the media server 430 and receives the media content from the media server 430 as a response to the request.

The reproduction unit 616 inserts the advertisement received by the advertisement interface unit 612 into the media content received by the content interface unit 614, and reproduces the media content having the advertisement.

The exemplary embodiments can be written as computer programs and can be implemented in general-use digital computers that execute the programs using a computer readable recording medium which has the computer program(s) encoded thereon. In addition, a data structure used in the exemplary embodiments can be recorded in a computer readable recording medium through various means. Examples of the computer readable recording medium include magnetic storage media (e.g., ROM, floppy disks, hard disks, etc.), and optical recording media (e.g., CD-ROMs, or DVDs).

While the exemplary embodiements have been particularly shown and described, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the exemplary embodimetns are defined not by the detailed description but by the appended claims, and all differences within the scope will be construed as being included in the exemplary embodiments.

1. A content reproduction method enabling a client to reproduce a media content, the content reproduction method comprising:
selecting an advertisement to be inserted in the media content by referring to information about advertisements which are insertable into the media content; and
receiving the media content from a media server, inserting the selected advertisement into the received media content, and reproducing the media content having the selected advertisement inserted therein.

2. The content reproduction method of claim 1, wherein the selecting of the advertisement comprises:
requesting an advertisement server to transmit the information about the advertisements which are insertable into the media content;
receiving the information about the advertisements which are insertable into the media content as a response to the requesting; and
selecting the advertisement to be inserted in the media content, based on the received information.

3. The content reproduction method of claim 2, wherein the selecting of the advertisement based on the received information comprises selecting one of a plurality of categories, the plurality of categories comprising a type of a product advertised by the advertisement, a person appearing in the advertisement, and a company advertised by the advertisement.

4. The content reproduction method of claim 3, wherein the receiving the media content from the media server, the inserting the selected advertisement into the received media content, and the reproducing the media content having the selected advertisement inserted therein comprises:
requesting the media content from the media server, and receiving the media content as a response to the requesting the media content;
requesting the advertisement in the selected one of the plurality of categories from the advertisement server and receiving the advertisement in the selected one of the plurality of categories from the advertisement server as a response to the requesting the advertisement; and
inserting the advertisement in the selected one of the plurality of categories received from the advertisement server into the media content received from the media server, and reproducing the media content having the advertisement in the selected category inserted therein.

5. The content reproduction method of claim 4, wherein the advertisement server registers the category selected by the client as an category-of-interest of the client.

6. The content reproduction method of claim 4, wherein the inserting of the advertisement and the reproducing of the media content comprises inserting into the media content another advertisement in a category similar to the selected one of the plurality of categories and reproducing the media content having the advertisement and the another advertisement inserted therein.

7. The content reproduction method of claim 4, wherein the receiving of the advertisement in the selected one of the plurality of categories further comprises receiving additional information about the advertisement in the selected one of the plurality of categories from the advertisement server.

8. The content reproduction method of claim 7, wherein the reproducing of the media content further comprises, after the reproduction of the media content is completed, extracting the advertisement in the selected one of the plurality of categories from the media content and reproducing separately the advertisement in the selected one of the plurality of categories, and providing the additional information to a user of the client.

9. A client for reproducing a media content, the client comprising:
an advertisement interface unit which selects an advertisement to be inserted in the media content by referring to information about advertisements which are insertable into the media content;
a content interface unit which receives the media content from a media server; and a reproduction unit which inserts the selected advertisement into the received media content, and reproduces the media content having the selected advertisement inserted therein.

10. The client of claim 9, wherein the advertisement interface unit sends a request to an advertisement server to transmit the information about the advertisements which are insertable into the media content, receives the information about the advertisements which are insertable into the media content as a response to the request, and selects the advertisement to be inserted in the media content from among the advertisements, based on the received information.

11. The client of claim 10, wherein the advertisement interface unit selects one of a plurality of categories comprising a type of a product advertised by the advertisement, a person appearing in the advertisement, and a company advertised by the advertisement, and the advertisement server provides the advertisement from the selected one of the plurality of categories to the advertisement interface unit to be inserted in the media content.

12. The client of claim 11, wherein the reproduction unit inserts the advertisement from the selected one of the plurality of categories into the media content which is requested from the media server and received by the content interface unit as a response to the request.

13. The client of claim 12, wherein the reproduction unit inserts another advertisement into the media content, wherein the another advertisement is in a category similar to the selected one of the plurality of categories, and reproduces the media content having the advertisement and the other advertisement inserted therein.

14. The client of claim 12, wherein the advertisement interface unit receives additional information about the advertisement in the selected one of the plurality of categories from the advertisement server, and after the reproduction of the media content is completed, the reproduction unit extracts the advertisement in the selected one of the plurality of categories from the media content and separately reproduces the advertisement in the selected category one of the plurality of categories, and provides the additional information to a user of the client.

15. A content publication method of publishing a media content by a first client for providing the media content to a second client, the content publication method comprising:
receiving information about advertisements which are insertable into the media content to be provided to the second client;
selecting an advertisement to be inserted in the media content, based on the received information; and
transmitting information about the selected advertisement and the media content, to enable the second client to insert the selected advertisement in the media content and to reproduce the media content having the selected advertisement inserted therein.

16. The content publication method of claim 15, wherein the receiving of the information about the advertisements comprises receiving the information about the advertisements from an advertisement server which stores the information about the advertisements insertable into the media content.

17. A content reproduction method enabling a second client to reproduce a media content published by a first client, the content reproduction method comprising:
transmitting a transmission request about the media content to a media server which provides the media content; and
receiving the media content from the media server, inserting an advertisement selected by the first client into the received media content, and reproducing the media content having the selected advertisement inserted therein.

18. The content reproduction method of claim 17, wherein the first client receives information about advertisements which are insertable into the media content from an advertisement server, and selects an advertisement to be inserted in the media content from among the advertisements, based on the received information.

19. A first client for publishing a media content to be provided to a second client, the first client comprising:
an advertisement interface unit which receives information about advertisements which are insertable into the media content to be provided to the second client, selects an advertisement to be inserted in the media content from among the advertisements, based on the received information, and transmits information about the selected advertisement; and
a content interface unit which transmits the media content, to enable the second client to refer to the information about the selected advertisement and reproduce the media content having the selected advertisement inserted therein.

20. A second client for reproducing a media content published by a first client, the second client comprising:
a content interface unit which transmits a transmission request for the media content to a media server which provides the media content, and receives the media content from the media server as a response to the transmission request; and
a reproduction unit which inserts an advertisement selected by the first client into the received media content, and reproduces the media content having the selected advertisement inserted therein.

21. A computer readable recording medium having recorded thereon a program which causes a computer to execute the content reproduction method of claim 1.

22. A computer readable recording medium having recorded thereon a program which causes a computer to execute the content publication method of claim 15.

23. A computer readable recording medium having recorded thereon a program which causes a computer to execute the content reproduction method of claim 17.

24. The content reproduction method of claim 7, wherein the additional information includes at least one of a specification of an advertised product in the advertisement, a profile of an entertainer appearing in the advertisement, a history of an advertised company associated with the advertisement, and contact information related to ordering the advertised product in the advertisement.

25. The content publication method of claim 16, wherein the information about the selected advertisement is transmitted to an advertisement server and the information about the media content is transmitted to a media server, and
the second client receives the selected advertisement from the advertisement server, receives the media content from the media server, inserts the selected advertisement in the media content, and reproduces the media content having the selected advertisement inserted therein.

26. A content reproduction method enabling a client to reproduce a media content, the content reproduction method comprising:
receiving advertisement library information from an advertisement server, the advertisement library information corresponding to advertisements stored in the advertisement server which are insertable into the media content;
selecting an advertisement to be inserted in the media content from among the advertisements by referring to the advertisement library information;
receiving the media content from a media server;
receiving the selected advertisement from the advertisement server;
inserting the selected advertisement into the received media content; and
reproducing the received media content having the selected advertisement inserted therein.

27. The content reproduction method of claim 26, wherein each of the advertisements stored in the advertisement server is designated with at least one category, the advertisement server receives category information corresponding to the media content from the client, and the advertisement server generates the advertisement library information to include only those advertisements which have the at least one category which corresponds to the category information of the media content.

28. The content reproduction method of claim 26, wherein the selecting of the advertisement includes selecting one of the advertisements directly from an advertisement listing provided by the advertisement library information.

29. The content reproduction method of claim 26, wherein the selecting of the advertisement includes selecting one of a plurality of categories of advertisements, and the advertisement server selecting one of the advertisements stored therein which corresponds to the selected category.

30. A system for publishing and reproducing a media content, the system comprising:
an advertisement server which stores a plurality of advertisements;
a first client which publishes a media content and selects at least one of the plurality of advertisements to be inserted into the media content;
a media server which stores the published media content transmitted from the first client; and
a second client which receives the published media content from the media server, receives the selected at least one advertisement from the advertisement server, inserts the selected at least one advertisement into the published media content, and reproduces the published media content having the selected at least one advertisement inserted therein.

31. The system of claim 30, wherein the first client transmits selected advertisement information about the selected at least one advertisement to the advertisement server, the selected advertisement information comprising a type of the published media content, a list of the selected at least one advertisement, and position information indicating positions of the published media content where each of the selected at least one advertisement is to be inserted in the published media content

32. The system of claim 31, wherein the second client receives the selected advertisement information from the advertisement server, and reproduces the published media content having the selected at least one advertisement inserted therein based on the selected advertisement information.
